(19) United States
(12) Patent Application Publication
(10) Pub. No.: US 2017/0154472 A1
(43) Pub. Date: Jun. 1, 2017

(54) SYSTEM AND METHOD FOR DETERMINING CUSTOM SIZES BY VISUAL ANNOTATION

(71) Applicant: VPERSONALIZE INC, San Francisco, CA (US)

(72) Inventor: BALAMURUGAN SELVARAJAN, Bangalore (IN)

(21) Appl. No.: 15/340,985

(22) Filed: Nov. 2, 2016

Related U.S. Application Data
(60) Provisional application No. 62/251,864, filed on Nov. 6, 2015.

(51) Int. Cl. G06T 19/00; A41H 1/02; A41H 3/00; G06T 11/60; G06K 9/00

(52) U.S. Cl. CPC G06T 19/006; G06T 11/60; G06K 9/00369; A41H 3/007; A41H 1/02; G06T 2210/16

(57) ABSTRACT

A system and method for determining a clothing size of a user using visually annotation, without the need for exact measurements methods, is provided. The system includes a parameterization module for selecting a reference model and base pattern a visual annotation module configured to receive a plurality of customizations for the clothing size as a plurality of points, a custom-size determination module configured to compute ratios of change of points relative to the reference model and applying the said ratios as transformations to the respective points of the base pattern to create a new graded, custom fit pattern.

### CROSS-REFERENCE TO RELATED APPLICATION

The embodiments herein claim the priority of the U.S. Provisional Patent Application with Ser. No. 62/251,864 filed on Nov. 6, 2015, with the title, “DETERMINING CUSTOM SIZED BY VISUAL ANNOTATION FOR CUSTOM MANUFACTURING”, and the contents of which is included entirely as reference herein.

### BACKGROUND

Technical Field

The present invention is generally related to merchandise and manufacturing of clothes. The present invention is particularly related to a system and method for custom manufacturing of clothing. The present invention is more particularly related to a system and method for determining the custom-size of a clothing through visual annotation.

Description of the Related Art

Made to measure (M2M) typically refers to clothing that is sewed from a custom-size based pattern. The fit of a made-to-measure garment is expected to be superior to that of a ready-to-wear clothing, as the ready-to-wear clothing is constructed to fit the manufacturer's definition of an average customer, while made-to-measure or custom sized clothing is constructed to fit each customer individually. The primary benefits to a customer of the made-to-measure clothing is that the garments are well-fitted to the customer's body and also provide an option to customize various parameters such as fabric, detailing, length, breadth, and the like.

Generally, to order a custom-tailored clothing, a plurality of measurements is first taken by a concerned person at a physical location. With the advent of the technology, there are ways in which the customer provides customized measurements and designs to the manufacturer through electronic devices. Some of the ways include providing a body shape identity, transmitting required measurements and designs with instructions, overlaying the desired fit on a scanned body image, and the like. Even though said methods allow customers to customize the design and fit, it is often difficult for the manufacturers to determine and gauge the exact custom fit and design, and translate the same during the manufacturing. Also, it is often difficult for an untrained consumer to accurately specify the exact measurements they need and for the remanufacturer to accurately interpret the measurements to create a fit garment.

Hence, there is a need for a simple system and method for a lay consumer to be able to accurately communicate a custom-size of the clothing that can be used by a manufacturer to create a garment for each customer. Further, there is a need for a system and method for manufacturing the custom-size clothing accurately. Still further, there is a need for a system and method for determining the custom-size of a customer through direct visual annotation

The above-mentioned shortcomings, disadvantages, and problems are addressed herein and which will be understood by reading and studying the following specification.

### OBJECTS OF THE EMBODIMENTS HEREIN

The primary object of the embodiments herein is to provide a visual tool for a user for customizing a clothing using visual annotation.

Another object of the embodiments herein is to determine a custom-size of the clothing as determined by a lay user using transformation techniques.

Yet another object of the embodiments herein is to enable the user to visually annotate the clothing customization using a simple rubber-banding technique (drag and drop).

Yet another object of the embodiments herein is to receive the custom-size provided by the user as a plurality of points.

Yet another object of the embodiments herein is to provide a user-friendly interface to the user for determining custom-size of the clothing.

These and other objects and advantages of the embodiments herein will become readily apparent from the following detailed description taken in conjunction with the accompanying drawings.

### SUMMARY OF THE EMBODIMENTS HEREIN

The various embodiments herein provide a system and method for determining custom-size of a clothing using visual annotation. Typically, a user draws or visually annotates an area around a model to determine the customizations such as fit, ease, length and other measurements as desired. The system receives the custom-size of the clothing and stores as a plurality of points with reference to a base pattern. The base pattern includes a plurality of predetermined parameters which are stored as points. The plurality of points includes, but are not limited to shoulder point, waist point, bust points, neck point. Further, the system computes a change in ratios of points with reference to the base pattern. Additionally, a new base pattern is created by applying the said ratios to create a transformation to the respective points of the base pattern and the paths are redrawn to match the corresponding curvature, thereby creating a new graded pattern. The new graded pattern, thus created, represents the original clothing fit to the user's custom measurements.

The system for determining the clothing size of the user includes a plurality of components including, but riot limited to a parameterization module, a visual annotation module, a custom-size determination module, a transmitting module, and a database.

The parameterization module includes a plurality of points as a data set for a reference human model that is annotated upon.

The visual annotation module is communicatively connected to the parameterization module and is configured to receive a plurality of customizations for the clothing size as a plurality of points. The plurality of customizations is received by prompting the user to customize the clothing with reference to the base model or image haying a base pattern using a visual annotation method.

The custom-size determination module is communicatively connected to the visual annotation module and is configured to compute ratios of change of points relative to the reference model image. The computed ratios are applied to the base pattern to create a second graded pattern/customized pattern before manufacturing.

The transmitting module is configured to transmit the computed ratios or the created second graded pattern/customized pattern to a manufacturing unit. The transmitting module is configured to transmit the created second graded pattern to the manufacturing unit located remotely using a communication network.

The database is configured to store a plurality of data related to the custom-size determination including a plurality of reference models with a plurality of reference points, having a plurality of base patterns, the unique identifiers of the users, and a plurality of protocols for operating the system. The database is located locally or remotely and accessed using a plurality of database query techniques.

The user inputs a plurality of details to the parameterization module and the custom-size determination module through a user interface of the computing device. The computing device is selected from a group consisting of a smartphone, a palmtop, a tablet, a wearable device, a virtual reality device, a smart television, and an augmented reality device.

The data is input through the computing device using an application program. The application program is selected from a group consisting of a mobile application, a web application, an application accessed through a browser, and a native application for the computing device.

The parameterization module includes a selection module that is configured to prompt the user to enter a plurality of details, and wherein the plurality of the details include, type of clothing, the gender of the user, ethnicity of the user, and preference of the user.

The visual annotation module is configured to store a plurality of reference points of the model image. The plurality of the reference points includes a shoulder point, a bust point, a waist point, a hip point, a height point, and a face point.

The reference model image is created using, the data from the selection module to choose the appropriate statistical data for a population or a body scanner data that determines a plurality of points required by the user to customize the clothing size. The user has the option to visually annotate the custom-size using the model created by the body scanner.

The various embodiments herein provide a computer implemented method for determining a clothing size of a user. The method includes selecting a reference model and base pattern, receiving a plurality of customizations by the user as a plurality of points using a visual annotation module, computing ratios of change of points relative to the reference model image and further applying the computed ratios to the base pattern to create a second graded/customized pattern, transmitting the created second graded/customized pattern to a manufacturing unit through a transmitting module, and storing a plurality of data related to the custom-size determination in a database for manufacturing.

According to an embodiment herein, each user is assigned a unique identifier post registration. Further, the plurality of customizations is received through visual annotation and by prompting, the user to customize the clothing with reference to a model having a predetermined base pattern.

According to an embodiment herein, the second graded/customized pattern is created by applying a transformation to the respective received points and a plurality of paths are redrawn to match a curvature when compared to the predetermined base pattern.

According to an embodiment herein, the transmission of the second graded/customized pattern is through a communication network.

According to an embodiment herein, the step of storing the data in the database includes a plurality of reference model images having a plurality of base patterns, a plurality of the unique identifiers of the users, a plurality of protocols for operating the system, and wherein the database accessed using a plurality of database query techniques.

The user inputs a plurality of details to the selection module and the custom size determination module through a user interface of a computing device. The computing device is selected from a group consisting of a smartphone, a palmtop, a tablet, a wearable device, a virtual reality device, and an augmented reality device. The data is input through the computing device using an application program, and wherein the application program is selected from a group consisting of a mobile application, a web application, an application accessed through a browser, and a native application for the computing device.

According to an embodiment herein, the parameterization module includes measurements from statistical population data, model data, and reference apparel patterns. It further includes a digitizing method to extract the measurement data from a body scanner or similar device.

According to an embodiment herein, the step of receiving a plurality of customizations by visual annotation module includes storing a plurality of reference points of the model image and the plurality of the reference points include a shoulder point, a bust point, a waist point, a hip point, a height point, and a face point. The reference model image is created using a body scanner that determines a plurality of points required by the user to customize the clothing size.

According to an embodiment herein, the method further includes providing an option to the user to visually annotate the custom-size using a body scanner.

The various embodiments herein provide a system and method for determining a custom size of an apparel or accessory by visual annotation, for subsequent use in grading to create a custom fit pattern. The system includes a visual tool, a custom-size determination module, and a processor.

The visual tool is configured for displaying a reference body model and a scaled apparel from corresponding to a base apparel pattern. The custom-size determination module is configured to customize the apparel in relation to the body model and further configured to compute a ratio of change of points, relative to the apparel form and the processor configured to apply the computed ratios to the base pattern to create a new custom graded pattern.

According to an embodiment herein, the body model is created using, a body scanner that determines a plurality of points required to customize the clothing size.

According to an embodiment herein, the scaled apparel form is created from the output of the body scanner in reference to the current clothing being worn by the user.

According to an embodiment herein, the visual annotation is replaced by textual cues, wherein the textual cues include knee-length, ankle-length, comfort fit, and tight fit.

The various embodiments herein provide a computer implemented method for determining a clothing size of a user, the method includes receiving a plurality of customizations by the user as a plurality of points through visual annotation in reference to a base model having a predetermined base pattern, referencing to the base model having a predetermined base pattern, computing ratios of change of points relative to the reference model, applying the computed ratios to each of the reference points on the base pattern to determine the transformed points, and redrawing the paths between the transformed points to match the curvature of the corresponding parts.

According to an embodiment herein, the plurality of reference points at least include a shoulder point, a bust point, a waist point, a hip point, and a height point.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment and the accompanying drawings in which:

FIG. 1 illustrates a block diagram of a system for determining custom-size for a clothing using visual annotation, according to an embodiment herein.

FIG. 2 illustrates a functional block diagram of system components required for determining custom size for a clothing, according to an embodiment herein.

FIG. 3A illustrates an interface provided to a user for receiving custom-size from the user, according to an embodiment herein.

FIG. 3B illustrates the visual annotation performed by the user on the model image, according to an embodiment herein.

FIG. 4 illustrates a plurality of points captured for determining custom-size for the clothing, according to an embodiment herein.

FIG. 5 illustrates a plurality of sizes, based on the graded/customized patterns created by the system using a visual annotation, according to an embodiment herein.

FIG. 6 illustrates a flowchart explaining a method for generating the custom graded pattern, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for determining custom-size of a clothing using a visual annotation. In one embodiment herein, a user draws or visually annotates an area around a model to determine the customizations such as fit, ease, length and other measurements as desired. The system receives the custom-size of the clothing and stores as a plurality of points with reference to a base pattern. The base pattern includes a plurality of predetermined parameters which are stored as points. The plurality of points includes, but are not limited to shoulder point, waist point, bust points, neck point. Further, the system computes a change in ratios of points with reference to the base pattern. Additionally, a new base pattern is generated by applying the said ratios to create a transformation to the respective points of the base pattern and the paths are redrawn to match the corresponding curvature, thereby creating a new graded pattern. The new graded pattern, thus created, represents the original clothing, fit to the user's custom measurements.

The method of visual annotation obviates the need for exact measurements, thereby enabling a lay user o accurately communicate a custom sizing information that can be used to create a new apparel pattern from a base pattern.

The system for determining the clothing size of the user includes a plurality of components including, but not limited to a parameterization module, a visual annotation module, a custom-size determination module, a transmitting module, and a database.

The parameterization module includes measurements from statistical population data, model data, and reference apparel patterns, it further includes a digitizing method to extract the measurement data from a body scanner or similar device. In one embodiment herein, the parameterization module includes a selection module that is configured to prompt the user to enter a plurality of details, and wherein the plurality of the details include, type of clothing, the gender of the user, ethnicity of the user, and preference of the user.

The parameterization module consists of a plurality of points as a data set for a reference human model that will be annotated upon. The visual annotation module is communicatively connected to the parameterization module and is configured to receive a plurality of customizations for the clothing size as a plurality of points. The plurality of customizations is received by prompting the user to customize the clothing with reference to the base model or image using visual annotation.

The visual annotation module is communicatively connected to the registration module and is configured to receive a plurality of customizations for the clothing size as a plurality of points. The plurality of customizations is received by prompting the user to customize the clothing with reference to a model image having a base pattern using visual annotation.

The custom-size determination module is communicatively connected to the visual annotation module and is configured to compute ratios of change of points relative to the reference model image The computed ratios are applied to the base pattern to create a second graded pattern/customized pattern.

The transmitting module is configured to transmit the computed ratios or the created second graded pattern/customized pattern using a communication network.

The database is configured to store a plurality of data related to the custom-size determination including a plurality of reference model images having a plurality of base patterns, the unique identifiers of the users, and a plurality of protocols for operating the system. The database is located remotely and accessed using a plurality of database query techniques. In another embodiment, a database is configured to store a plurality of data related to the custom-size determination including a plurality of reference models with a plurality of reference points for a plurality of base patterns. The database is in-memory, located locally or remotely and accessed using a plurality of search techniques.

The user inputs a plurality of details to the parameterization module and the custom-size determination module through a user interface of the computing device. The computing device is selected from a group consisting of a smartphone, a palmtop, a tablet, a wearable device, a virtual reality device, a smart television, and an augmented reality device.

According to an embodiment herein, the data is input through the computing device using an application program. The application program is selected from a group consisting of a mobile application, a web application, an application accessed through a browser, and a native application for the computing device.

According to an embodiment herein, the parameterization module includes a selection module that is configured to prompt the user to enter a plurality of details, and wherein the plurality of the details include, type of clothing, the gender of the user, ethnicity of the user, and preference of the user.

The visual annotation module is configured to store a plurality of reference points of the model image. The plurality of the reference points includes a shoulder point, a bust point, a waist point, a hip point, a height point, and a face point and in any case, at least includes a bust point and height point. The stored model is either in 3D or 2D.

The reference model is created using, the data from the parameterization module to choose the appropriate statistical data for a population or a body scanner that determines a plurality of points required by the user to customize the clothing size. The user has the option to visually annotate the custom-size us tag the model created from the body scanner.

The various embodiments herein provide a computer implemented method for determining a clothing size of a user. The method includes receiving a plurality of customizations by the user as a plurality of points using a visual annotation module, computing ratios of change of points relative to the reference model image and further applying the computed ratios to the base pattern to create a second graded/customized pattern.

According to an embodiment herein, each user is assigned a unique identifier. Further, the plurality of customizations is received through visual annotation and by prompting the user to customize the clothing with reference to a model image having a predetermined base pattern and computing ratios of change of the reference points.

Applying said ratios directly to transform the base pattern in certain cases, result in pattern pieces that don't fit. One example of this is the curvature of the armhole (Scye) and the curvature of the Sleeve Cap, which cannot be stitched together if they are not matching. According to an embodiment herein, the second graded/customized pattern is, therefore, created by applying the transformation to the respective received points on the base pattern and redrawing the paths between the points to match the curvature of the corresponding parts.

According to an embodiment herein, the transmission of the second graded/customized pattern is through a communication network. In another embodiment, the ratios are transmitted in place of the patterns and are used to create the graded pattern on a different computing device at a later time.

According to one embodiment herein, a database is used and the step of storing the data in the database includes a plurality of reference model images having a plurality of base patterns, a plurality of the unique identifiers of the users, a plurality of protocols for operating the system, and wherein the database accessed using a plurality of search techniques.

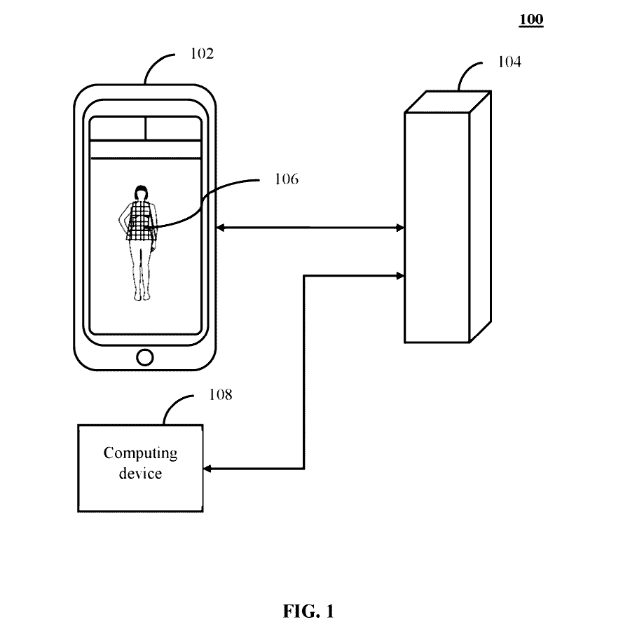

The various embodiments herein provide a system and method for determining custom-size of a clothing using a visual annotation. FIG. 1. illustrates a block diagram of a system for determining custom-size of a clothing using visual annotation, according to an embodiment herein. The block diagram includes two example computing device 102 and 108, and an application server 104. The computing device 102 is shown to be a mobile device, while 108 is shown to be a traditional computing device like PC. In one embodiment, the user provides a custom-size for the clothing with reference to a model 106 using visual annotation. The custom-size is provided by the user through the computing device 102 or 108. The provided custom-size is processed by the application server 104 and optionally transmitted to a manufacturing unit or to a storage location, preferably for initiating the manufacturing of the designed custom-size cloth. The computing device 102, 108 and the application server 104 communicate with each other through a communication network (not shown in the figure). The examples of the communication network include, but are not limited to an intranet, the interact, a telecommunication network, a radio-frequency network, a local area network (LAN), metropolitan area network (MAN), wide area network (WAN), wired, and wireless network.

According to an embodiment herein, the computing device 102 and 108, is a device capable of establishing communication with other computing devices and has the capacity to render and modify the images transmitted by the application server 104. The examples of the computing device include, but are not limited to a smartphone, a laptop, a palmtop, a desktop computer, a wearable device, a personal computer, a wearable device, a smart television, a virtual reality device, and an augmented reality device. The tasks of the application server 104 perform by the computing device 102 or 108, provided it has sufficient computational capacity.

Typically, the user provides the custom-size of the clothing by visually annotating on the model 106. Typically, the model/image 106 has pre-determined points such as shoulder points, waist points, hip points, knee points, and the like, corresponding to form a base pattern for the custom-size determination. The model image 106 presented to the user is either a 2D image or a 3D model. According to an embodiment herein, the model image 106 has a virtual clothing for which the user has to provide custom-size. According to an embodiment herein, the model 106 has no virtual clothing and the user has to draw the shape of the clothing using one or more input mechanisms. The option for visual annotation is provided on the computing device 102, 108, in a plurality of ways. The examples in which the visual annotation capability is provided includes a web-based application, a mobile application, a browser-based application and a native application. In one embodiment herein, the user provides the visual annotation using a rubber-banding technique which is essentially modifying the fit of the clothing by dragging and/or drawings the virtual clothing on the model.

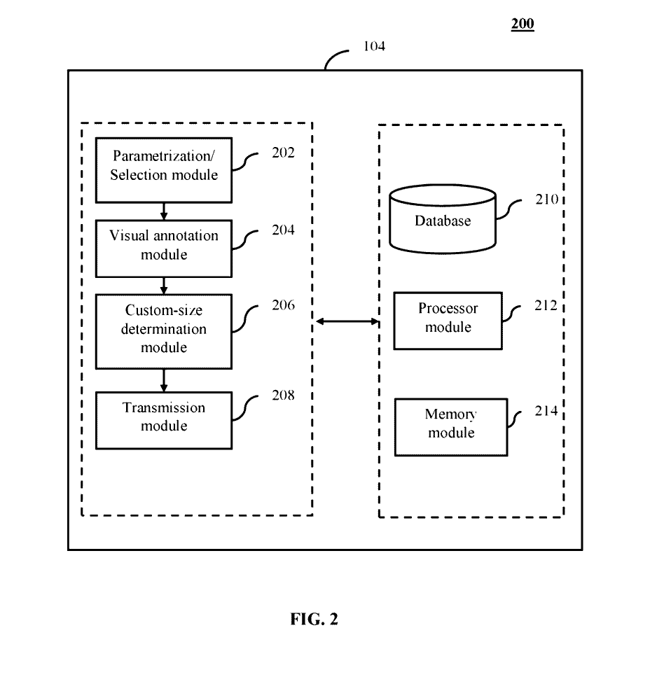

FIG. 2 illustrates system components required for determining custom-size for a clothing, according to an embodiment herein. The system components include a parameterization module 202, a visual annotation module 204, a custom-size determination module 206, a transmission module 208, a database 210, a processor module 212, and a memory module 214. According to an embodiment herein, the parameterization module 202 and the visual annotation module 204 form a front-end of the system and the rest of the modules namely the custom-size determination module 206, the transmission module 208, the database 210, the processor module 212, and the memory module 214 form the back-end of the system. The memory module 214 is part of either both or shared.

The parameterization module 202 consists of a plurality of points as a data set for a reference human model, measurements from statistical population data, model data, and reference apparel patterns. It further includes a digitizing, method to extract the measurement data from a body scanner or similar device.

The parameterization module 202 includes a selection module that is configured to prompt the user to enter a plurality of details, and wherein the plurality of the details include the type of clothing, the gender of the user, ethnicity of the user, and preference of the user. According to one embodiment herein, the Selection module further prompts the user for age, body measurements, height, and weight, wherein a few of the details are compulsory and a few of them are optional. The details gathered in the Selection module are used to present an accurate reference model and base pattern for visual annotation. Once the parametrization/selection module 202 receives user details. The visual annotation module 204 presents a model image to the user. The model image presented to the user is retrieved from the database 210 of appropriate statistical data for a population or a body scanner that determines a plurality of points required by the user to customize the clothing size. For example, when the details entered is for a Female, 25, Indian, searching for a T-shirt, 168 centimeters, the model image presented has a base pattern of an average India woman with the above said height and stature features. Similarly, when the details entered is for a Female, 32, searching for a skirt, Native American, 166 centimeters, the model image presented has the average features for that stature, derived from average population data or a body scan of the very individual customizing the clothing. Further, the visual annotation module 204 prompts the user to custom-size the clothing with reference to the presented model/image.

In case a body scan of the very user customizing the clothing is used as the reference pattern, the user creates a custom fit by visually annotating in reference to the very clothing currently being worn.

In one implementation, the model image presented includes a virtual clothing cladded to the model. The user is prompted to modify the size, fit, and design of the clothing using one or more standard techniques known in the art. The examples of the techniques used for modifying, the clothing cladded to the model using visual annotation includes modifying using a rubber-band technique, where the user has the option to drag and adjust each part of the clothing, without the need to enter any actual sizing data. Further, the user is also presented with an option to add and delete one or more parts of the virtual clothing to obtain the custom-fit. In other implementation, the model image presented to the user does not have a virtual clothing cladded to the model. The user has the option to draw the desired clothing design and fit the model image through the user interface of the computing device. The changes in the custom-tit are received as a plurality of points and are transmitted to the custom-size determination module 206.

A key aspect of the visual annotation module 206 is highlighting the changes of to the clothing size during custom-fit when compared to the original clothing cladded to the model/image. The highlighting and presenting custom-size in a visually different manner using visual comparison allow the user to compare and comprehend the difference when referenced to the original model, without the need for actual measurement data. For example, a user wanting to convert a knee length skirt to ankle length does so visually by dragging the hemline, while the custom-size determination module automatically computes the ratios that need to be applied to the base pattern to create such a clothing.

In one embodiment, the visual annotation module 204 receives the custom-size along with a plurality of other parameters such as clothing material, texture, print, and the like, presents a live-preview of the custom-size and the customizations provided by the user.

Once the custom-size determination module 206 receives the custom-size of the clothing as a plurality of points from the visual annotation module 204, a ratio of change is applied using transformation techniques. One of the examples of transformation techniques is affine transformation, which is used for transforming the original base pattern based on computing the change in the ratio of points as compared to the original base pattern of the model. The base pattern includes a plurality of predetermined parameters which are stored as points. The plurality of points includes, but are not limited to shoulder point, waist point, bust points, neck point. Further, the custom-size determination module 206 determines the change in the ratio and further computes a new grading pattern and redraws the paths to match the curvatures of corresponding parts (example: Scye to Sleeve cap) according to the required clothing material and manufacturing method

The transmission module 208 is communicably coupled to the custom-size determination module 206 and receives the computed ratios. The transmission module 208 further transforms the ratios, if necessary, before communicating the same to the custom manufacturing unit (not shown in the figure).

In one embodiment of this invention, the custom-size determination module only determines the ratios, which are transmitted by the transmission module, for later use in a backend to create the new graded/custom patterns at a later point in time.

The database 210 is communicably coupled with most of the components of the application server 104 and is configured to store the information regarding the user, user registration details, a plurality of identifiers, a plurality of models, population data, a plurality of base patterns and model image, a plurality of protocols used for critical operation of the application server, rules and regulations for operating the system, and the like. Further, the database 210 also includes a plurality of customizations provided by the user for custom manufacturing.

The system further includes a hardware processor 212 for controlling the operation of the application server 104 and process each of the instructions of the application server 104. According to an embodiment herein, the hardware processor 212 has the option to be upgraded and downgraded dynamically. Further, the hardware processor 214 has multiple variations such as single-core, dual-core, multi-core, and the like.

The system includes a memory module 214 configured to store information for immediate use of the application server 104. Typically, the memory module 214 includes a variety of memory such including but not limited to a primary memory, a secondary memory, a semiconductor memory, a cache memory and the like. The memory module 214 also has the option to add virtual memory for managing and upgrading the memory.

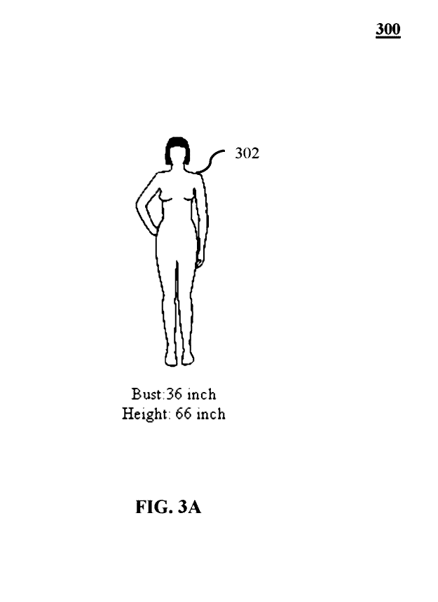

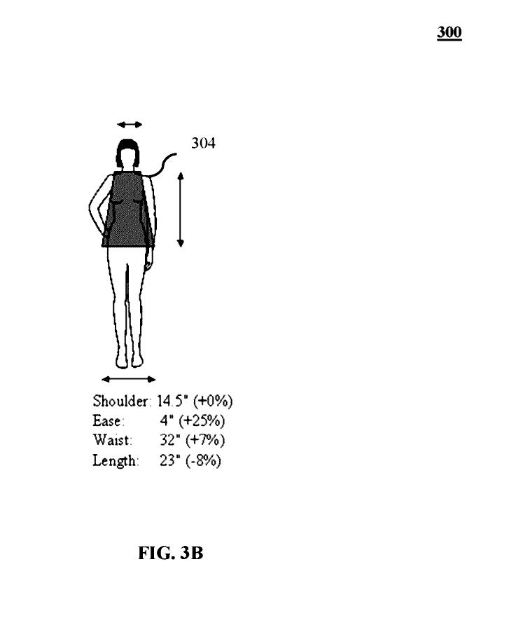

FIG. 3A illustrates an interface provided to a user for receiving custom-size from the user, according to an embodiment herein. The interface has a first model image 302 presented to the user, based on the information provided during selection or the output of a body scan.

FIG. 3B illustrates the visual annotation performed by the user on the model image, according to an embodiment herein. The visual annotation is performed using the user interface of the computing device. The visual annotation module presents the model image and the option to customize to the user. In the example cited in the FIG. 3B, the user has drawn the clothing of a top-wear and has provided the custom-size when referenced to the model image. In another embodiment, the clothing is drawn automatically in FIG. 3B based on a user input in the Selection module or a body scan of their current apparel. Further, the user, then, has the option to modify the custom-size of the clothing by using drag and drop, drag and modify resize options.

The custom-size provided by the user for a second model image 304 is captured by the visual annotation module as a plurality of points. In the example cited in FIG. 3B, the values of these changes based on the visual annotation are shown below the model. The custom-size and other customizations are highlighted in a different format (change in color, dotted/dashed line, etc) for easy visual comprehension.

In one embodiment of the invention, the user input, and visual annotation is replaced by textual, voice, multimedia or descriptive inputs. Some examples of descriptive input are knee length, ankle length, tight fit, athletic fit, comfort fit, etc.

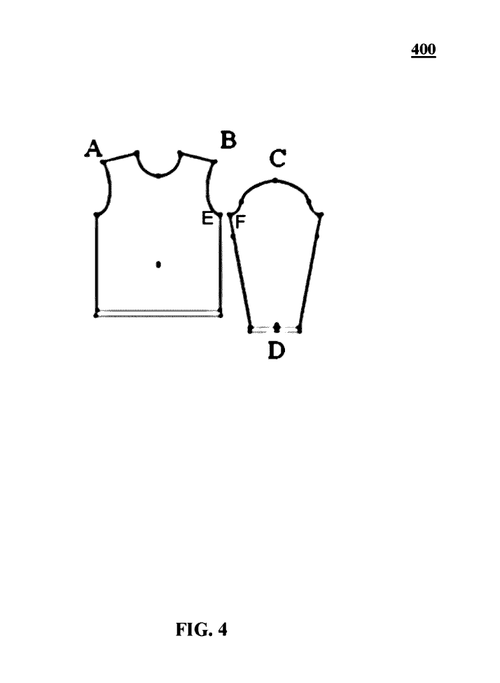

FIG. 4 illustrates a plurality of points captured on a base pattern for the transformation of custom-size for the clothing, according to an embodiment herein. As seen in the FIG. 4, the base pattern is captured as a plurality of points (highlighted by black dots) rather than capturing them as paths. In the FIG. 4, it is seen that the shoulder points is AB, sleeve length points is CD. Applying the ratio of changes from Visual Annotation directly to transform the base pattern, in certain cases, result in pattern pieces that don't fit. One example of this is the curvature of the arm hole (Scye represented by BE) and the curvature of the corresponding Sleeve Cap (represented by CF), which cannot be stitched together if they don't match. Capturing the base pattern as a series of points and applying the ratios as the transformation to the respective points and redrawing the paths between the points to match the curvature of the corresponding parts, obviates this problem.

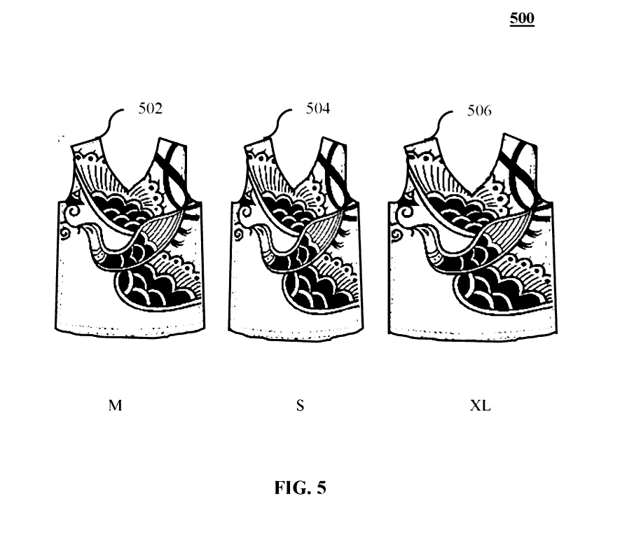

FIG. 5 illustrates a plurality of sizes, based on the graded/customized patterns created by the system using visual annotation, according to an embodiment herein. FIG. 5 illustrates a plurality of customizations of a top-wear in size S, M and XL by the user using visual annotations. The top-wear is custom-sized on the parameters of the bust point, and height point from the user.

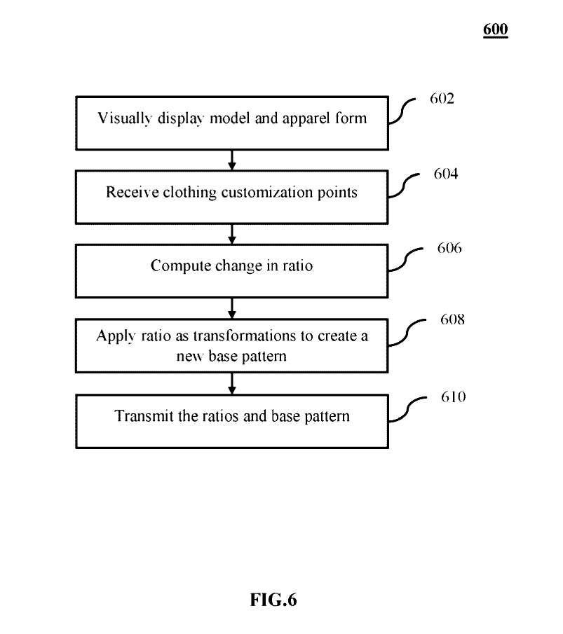

FIG. 6 illustrates a flowchart explaining a method for determining custom-size of a clothing, according to an embodiment herein. At first, a plurality of user details are received and is used to visually present a model and an apparel form (Step 602).

Once the model image is presented on the user interface of the computing device, the user provides custom-size for the clothing along with other customization parameters. The custom-size of the clothing is provided by the user using the visual annotation technique. The visual annotation technique allows the user to provide custom-size using a rubber hand technique where the user drags and drops the virtual clothing to provide custom-fit, without the need for entering exact measurement data. The visual annotation is substituted or augmented by other customization features using descriptive, audio, or multimedia annotation. The presented model image has predetermined base patterns which are selected based on a plurality of parameters such as ethnicity, height weight, bust size, type of fit (tight fit, comfort fit, and straight fit) and the like. The custom-size parameters are received as a plurality of points from the visual annotation module (Step 604).

Further, once the plurality of custom-size points is received, a change in the ratio of the points when compared to the predetermined base pattern is computed (Step 606). Additionally, a new base pattern is generated by applying the ratios as the transformation to the respective points of the, and the paths are redrawn to match the curvature of corresponding parts (Step 608).

Once a new graded pattern is created, the same is transmitted for further use in manufacturing or stored for later use (Step 610). According to an embodiment herein, the transmission is local and the data is stored locally on the computing device. In another embodiment of this invention, the transmission of the new graded patterns is enabled using the communication network.

In one embodiment of this invention, all the information regarding the operation of the custom-size determination is stored in a database (Step 610). The database is updated dynamically and has the option to be expanded as required.

The embodiments herein provide a system and method to visually annotate the custom-size for a clothing using a computing device and not requiring the user o be present at a physical location nor providing exact measurements. As an example, for 5′6″ Female mode, and an apparel that is drawn the knee level, the user has the option to visually pull the hemline to the ankle without having to specify any exact measurements. If the model was drawn to scale, from the population measurement data, it is known that for a Caucasian 5′6″ women, the distance of knee to ankle is 15.5 inches and center back to the knee is 39 inches. Thus calculating a ratio of the increase as 1.397 (39″ to 54.5″), which is applied to the knee length base pattern to create a new ankle length pattern

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A system and method for determining a custom size of an apparel or accessory by visual annotation, for subsequent use in grading to create a custom fit pattern, the system comprising:
a visual tool configured for displaying a reference body model and a scaled apparel form corresponding to a base apparel pattern;
a custom-size determination module configured to customize the apparel form in relation to the body model, and further configured to compute a ratio of change of points, relative to an original apparel form; and
a processor module configured to apply the computed ratios to the base pattern to create a new custom graded pattern.

2. The system according to claim 1, wherein the body model is created using a body scanner that determines a plurality of points required to customize the clothing size.

3. The system according to claim 1, wherein the scaled apparel form is created from the output of the body scanner in reference to the current clothing being worn by the user.

4. The system according to claim 1, wherein the visual annotation is replaced by textual cues, wherein the textual cues include knee-length”, “ankle-length”, “comfort fit”, and “athletic fit”.

5. The system according to claim 1, wherein the body model is replaced by an equivalent reference object such as a grid pattern.

6. A computer implemented method comprising instructions stored on a n transitory computer-readable storage medium and executed on a computing device with a hardware processor and a memory for determining a clothing size of a user, the method comprising the steps of:
receiving a plurality of customizations by the user as a plurality of points through visual annotation in reference to a base model having a predetermined base pattern;
referencing to the base model having a predetermined base pattern and computing ratios of change of points relative to the reference model;
applying the computed ratios to each of the reference points on the base pattern to determine the transformed points; and
redrawing the paths between the transformed points to match the curvature of the corresponding parts.

7. The method according to claim 5, wherein the plurality of reference points at least include a bust point and a height point, but more typically include a shoulder point, a bust point, a waist point, a hip point, and a height point.
